(19) United States
(12) Patent Application Publication
(10) Pub. No.: US 2026/0283079 A1
(43) Pub. Date: Sep. 24, 2026

(54) Device, system and method for non-chemical growth regulation of plants

(71) Applicant: Kars-Michiel Hubert Lenssen, Veldhoven (NL)

(72) Inventor: Kars-Michiel Hubert Lenssen, Veldhoven (NL)

(21) Appl. No.: 19/574,383

(22) Filed: Mar. 22, 2026

Related U.S. Application Data
(60) Provisional application No. 63/776,257, filed on Mar. 23, 2025.

(51) Int. Cl. A01G 7/04; H05B 47/155

(52) U.S. Cl. CPC A01G 7/045; H05B 47/155

(57) ABSTRACT

The present invention comprises a novel non-chemical solution for growth control of plant-like organisms, which makes use of UV-radiation, in particular far-UV radiation (200 nm-240 nm). The invention can also be used in lit environments since it is less prone to photoreactivation and is safer in case humans or fauna are exposed unintentionally. In contrast to chemical solutions it does not leave any residue behind. It cannot only be used to regulate the dimensions of plants (e.g. height), but also other characteristics, like branching, blossoming, enhanced production of secondary metabolites, inducing resistance to subsequent stressors or pathogens, etc. In an embodiment with a second source with radiation from a different wavelength range (e.g. 390 nm-780 nm) a system according to the invention can control the different radiation types (with different effects on the plants), based on input data, in such a way that optimal growth is achieved.

### CROSS REFERENCES TO PRIORITY APPLICATIONS

This application claims the benefit of U.S. Provisional Patent Application No. 63/776,257, filed March 23, 2025, which is hereby incorporated by reference.

### FIELD OF THE INVENTION

The present invention relates to a novel solution for growth regulation (growth control), in particular of plant-like organisms, for example growth inhibition while safeguarding the health of the organism. Particularly, the invention relates to non-chemical growth regulation.

### BACKGROUND OF THE INVENTION

In recent years it became clear that ultraviolet radiation (UV) can have positive effects on living organisms. For example, UV can be used to stimulate plant-defense responses, to increase the concentration of certain substances, to improve quality of production in fruits, for growth inhibition or against pathogens. (In the remainder the term plant growth control is understood to comprise all these effects that can be desirable.)

However, in practice UV-exposure is often not effective and/or shows undesired side-effects. For example, due to photoreactivation traditional UV-C (i.e. with wavelength around 254 nm) is not very effective if visible light is present during or after the UV-procedure. Because of this it has been proposed to use UV-C in the dark, but this is often not possible in agricultural/horticultural situations; moreover, plants generally need visible light to stay healthy.

Moreover, traditional UV-C (around 254 nm) can be dangerous for people and requires extensive safety measures and cannot be used when there is a risk of people being exposed. Also it is harmful for the fauna (wild animals that are present).

Therefore a need exists for a safer and more effective, non-chemical solution for plant growth regulation. Further, it is desirable that the solution can also be used in lit environments.

### SUMMARY OF THE INVENTION

It is an objective of the present invention to provide a non-chemical solution to regulate the growth of plants (this can be w.r.t. dimensions but also other features mentioned earlier) in a controlled way, which is safer for humans and fauna. It is another objective of the present invention to provide a versatile solution (e.g. not only applicable in dark environments, providing the option to increase and reduce growth, etc.)

In one embodiment of the present invention, a UV-source with an emission peak between 200 and 240 nm (for example around 207, 222 or 233 nm) is provided to expose the plants. The inventor of this invention has realized, based on his new experiments, that this so-called far-UV radiation is suitable for growth regulation. Moreover, it is easier to use and even more effective than the UV-C (254 nm) which is presently used, also since far-UV radiation is much less prone to photoreactivation, because it can (also) affect proteins in the plants or pathogens in an irreversible way. Therefore, it can also be used in environments with visible light. The latter also enables to use far-UV in combination with radiation sources of other wavelengths, e.g. visible light.

Another insight from the experiments of the inventor is that, depending on the dose, far-UV can also strengthen plants (e.g. make them more robust to future stress factors, including, but not limited to, temperature, drought, pathogens, etc.). This strengthening effect is typically observed for low doses and therefore flashes or pulses could be a preferred way to deliver strengthening doses to plants. Note that short pulses are not practically possible for traditional 254 nm UV-emitting low pressure mercury lamps (and frequent switching detoriates such lamps).

In another embodiment, the far-UV source is combined with a second source with a wavelength peak between 400 nm and 780 nm (e.g. 600 nm), which has a largely positive effect on the plant growth, e.g. stimulating photosynthesis. In this way a balance between the two types of radiation enables a controlled regulation of the plant growth. This can be done by a combination of the two radiation types, but in particular also by applying one type of radiation after the other, or alternating. This can also be easier in practice since only one emission window is needed in the apparatus, less power is required and/or each source can be brought in an optimal position w.r.t. to the plants. Note that all used radiation in this embodiment is much safer than the 254 nm UV-C which is presently used. This embodiment can be used for careful control and timing of plant growth (since it has both growth-inhibiting radiation, as well as growth-stimulating radiation), but is also useful in applications where growth inhibition is an undesired side effect (e.g. when stimulating plant-defense responses or for pathogen control).

In a specific version of these embodiments (one of) the source(s) consist(s) of a string or strip of connected light sources (e.g. LEDs) which can be placed (or even draped, if it is a flexible string) between the plants.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 schematically shows a device according to the present invention that comprises radiation sources with emissions of different wavelengths,

FIG. 2 illustrates a handheld device,

FIG. 3 illustrates a mobile (optionally self-driving) device,

FIG. 4 illustrates a flying device (optionally a drone),

FIG. 5 illustrates spatial separation by positioning the device at a height between the ground level and the tops of the plants,

FIG. 6 illustrates schematically a system that can control the radiation emissions based on input data (which could be, for example, manual input or a timer).

FIG. 7 illustrates schematically a system that can determine the required exposure based on input data about the present state and about the target state, and balance the type and dose of the radiation for optimal growth regulation.

### DETAILED DESCRIPTION

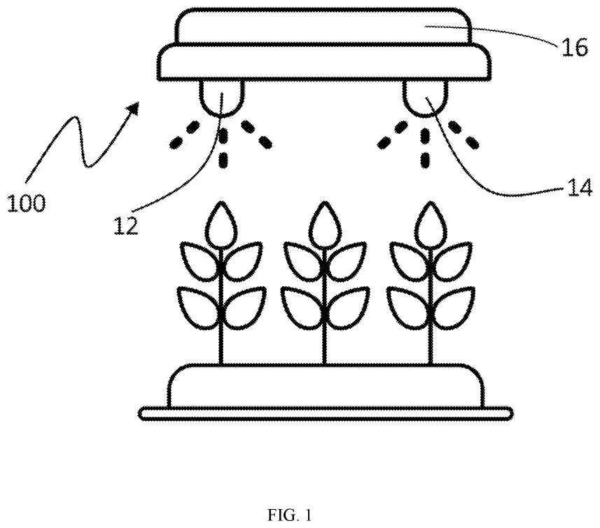

FIG. 1 shows a schematic representation of a device 100 according to the invention. It comprises at least a first radiation source 12, a second radiation source 14 (with a different emission spectrum) and a means 16 to control them independently (this means could, for example, be one or more manual switches, but also a more sophisticated control means). In a typical embodiment the first source emits growth-inhibiting, strengthening or disinfecting radiation (between 200 nm and 390 nm), while the second source emits photoreactivating radiation (typically between 390 nm and 500 nm) and/or photosynthesis-stimulating radiation (typically mainly in the wavelength ranges between 390 nm and 500 nm and between 600 and 760 nm).

In a preferred embodiment the first radiation source emits far-UV, i.e. with a significant part of the emitted radiation within the wavelength range 200 nm-240 nm. For example, it could be a Kr—Cl excimer lamp with a peak at 222 nm or a LED with a peak at 233 nm. The device 100 comprises also a second source 14 that emits radiation that is largely in a different wavelength range (and thus with different effects on plants), for example in the range 390 nm-780 nm. As a concrete example the second source could consist of red 600 nm LEDs or cool-white LEDs. The Figures show the emission from separate locations, but this does not need to be the case; the sources can also emit through the same optical exit window or could even be combined into one source (e.g. alternating LEDs on a strip).

In a special embodiment the source or sources do not emit radiation continuously for a prolonged time, but intermittently or in pulses. In this way the energy consumption can be reduced, while the biological effect is similar or even better.

The growth-inhibiting effect of far-UV and the growth-stimulating effect of the second radiation source could be used to balance each other and carefully control the growth (e.g. height or blossoming) of the plants. In another case, if the main goal is pathogen control or stimulation of defense-responses, it may be desired that the net growth change is zero (and the second source is used to compensate for a possible growth-inhibiting effect of the far-UV).

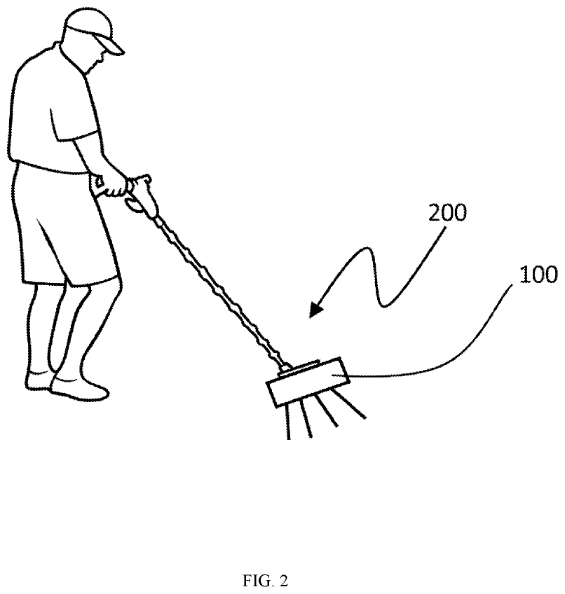

FIG. 2 shows a schematic representation of a handheld apparatus 200 comprising a device 100. A person can use this device to hold it near plants to expose them to the desired radiation.

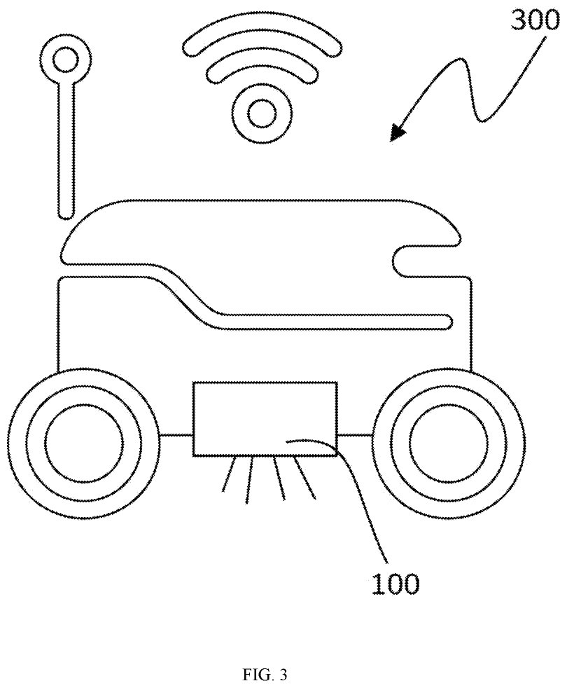

FIG. 3 shows a schematic representation of a mobile apparatus 300 comprising a device 100. In this example it can be a remotely controlled apparatus, but it could also be a self-driving vehicle. On the other hand, in a simpler embodiment it could be a mobile apparatus that is pushed (or pulled) forward by a person.

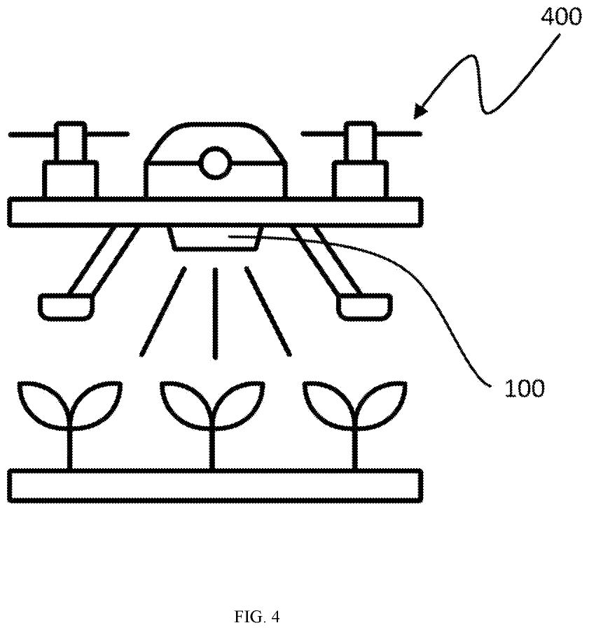

FIG. 4 shows a schematic representation of a flying apparatus 400 comprising a device 100. By flying above (or possibly between) the plants it can expose them with the desired radiation from device 100. It can be a remotely controlled apparatus or alternatively a self-flying drone.

In another analogous embodiment, which is not shown, device 100 is contained in a floating apparatus, which can be used, for example, to control growth of water plants.

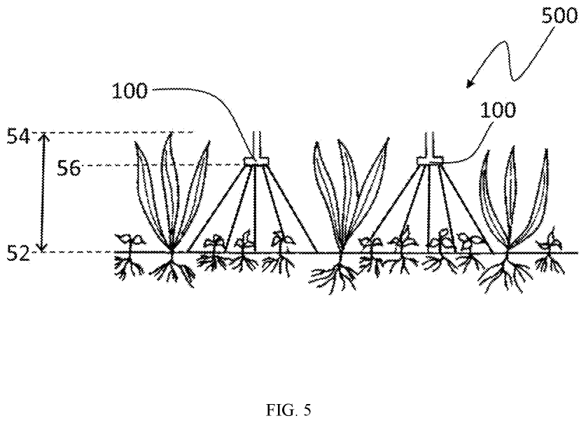

FIG. 5 shows a schematic representation of an installation 500 which uses a differentiation (separation) in radiation for different groups of plants, c.q. taller vs. shorter plants. The shorter plants could be emerging weed and the taller plants crop or ornamental plants. The separation is realized by placing the devices 100 between the level of the ground 52 and the level of the tops of the taller plants 54 on a level 56. In this way the weed receives a much higher dose than the crop, in particular if the radiation is mostly emitted downwards.

In this example the devices 100 are hanging (e.g. from the ceiling of a greenhouse), but in an advantageous embodiment of such an installation they could consist of a multitude of connected sources, e.g. a LED string or LED strip, which can be placed or wrapped between the plants.

Instead of (or in addition to) a spatial separation there can also be a separation in time. For example, the soil can be exposed to far-UV before crop or ornamental plants are sown or planted. In this way the growth of undesired plants (weed) is strongly inhibited or reduced, while the growth of the desired plants can proceed normally or even be enhanced e.g. by visible light.

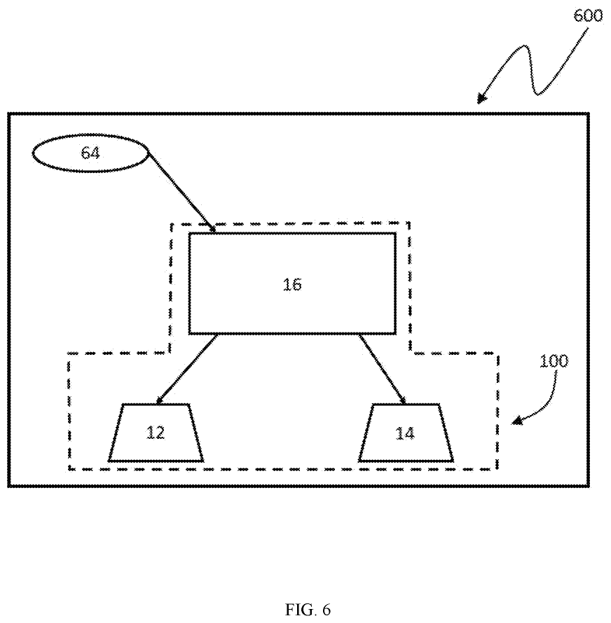

FIG. 6 shows a schematic representation of a system 600, comprising a device 100 with different radiation sources 12 and 14, in which the means to control the sources 16 comprises a controller (instead of e.g. only manual switches). As input the controller 16 gets data from input-providing means 64, which could, for example, be manual input from a control panel or input from a timer. Based on the input data the controller could execute a program. In a specific embodiment this program could apply a method to first expose plants with radiation from the first radiation source (e.g. for disinfection or stimulation of plant-defense responses), followed by a second exposure with radiation from the second radiation source (e.g. to compensate for the caused growth inhibition, at least partially). These exposures may or may not overlap in time and may also be repeated, if needed.

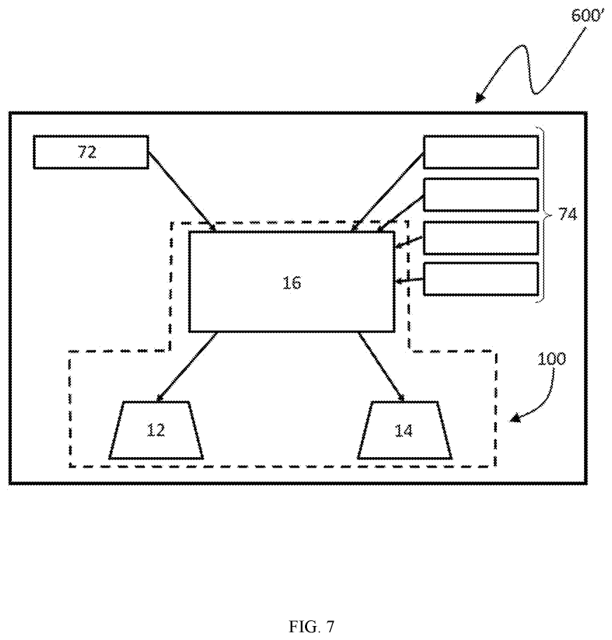

FIG. 7 shows a schematic representation of a system 600', comprising a means to control the sources 16 comprising a controller and a device 100 with different sources 12 and 14. As input the controller gets data about the desired target state 72 (they could for example be stored in a memory in the system or be sent wirelessly) and data about the present state 74 (these could, for example, be data measured by one or more sensors, and/or date & time, etc.). Sensors could, for example, be a chlorophyll spectrometer or a plant-height sensor, but also AI-powered image recognition. Based on these input data the controller determines the type and dose of radiation that is needed to achieve the desired target state of the plants and operates the sources 12 and 14 accordingly.

In practice the data about the desired target state 72 could also be data ranges, and a radiation source 12 and/or 14 is switched on by the controller if the measured data 74 indicate that the present state is near an edge of the range or already outside the range.

It will be obvious for a person skilled in the art that the described embodiments can be extended/combined with other measures, e.g. more sources (with different wavelength ranges), other sensors (visual, but also for chemicals, e.g. gases and/or ambient conditions like light level, temperature, humidity, etc.). The embodiments can also be combined with radiation for pathogen reduction or be used to enhance the effect of substances, heat, etc.

As already mentioned earlier, by growth control not only plant dimensions (e.g. height) are meant, but it can also concern branching, blossoming, enhanced production of secondary metabolites, inducing resistance to subsequent stressors or pathogens, etc.

For the purpose of this invention plant-like organisms comprises plants, algae and fungi. All these organisms except cyanobacteria have eukaryotic cells. Lichens are considered also in the scope of this invention since a lichen is a symbiotic association between a fungus and a photosynthetic organism (e.g. an alga).

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

1. A device for growth control of plant-like organisms, comprising:
a first radiation source with an emission peak in the wavelength range between 200 nm and 390 nm;
a second radiation source with an emission peak in the wavelength range between 390 nm and 780 nm; and
a means allowing to control the sources independently of each other.

2. A device according to claim 1, wherein the first radiation source has a growth-inhibiting effect on the plant-like organisms.

3. A device according to claim 1, wherein the first radiation source has an emission peak in the wavelength range between 200 nm and 240 nm.

4. A device according to claim 3, wherein the second radiation source has an emission peak in the wavelength range between 390 and 500 nm.

5. A device according to claim 3, wherein the second radiation source has an emission peak in the wavelength range between 600 and 760 nm.

6. A device according to claim 1, wherein both radiation sources are emitting simultaneously at least for a period of time.

7. A device according to claim 3, wherein both radiation sources are emitting simultaneously at least for a period of time.

8. A device according to claim 5, wherein both radiation sources are emitting simultaneously at least for a period of time.

9. A device according to claim 1, wherein the second radiation source is emitting for a period of time after the first source was switched off.

10. A device according to claim 3, wherein the second radiation source is emitting for a period of time after the first source was switched off.

11. A device according to claim 5, wherein the second radiation source is emitting for a period of time after the first source was switched off.

12. A device according to claim 1, wherein the emission of at least the first radiation source is pulsed.

13. A device according to claim 3, wherein the emission of at least the first radiation source is pulsed.

14. A device according to claim 5, wherein the emission of at least the first radiation source is pulsed.

15. A self-driving, self-flying or self-floating apparatus, comprising a device according to claim 3.

16. A self-driving, self-flying or self-floating apparatus, comprising a device according to claim 5.

17. A system for growth control of plant-like organisms, comprising:
a first radiation source with an emission peak in the wavelength range between 200 nm and 390 nm;
a second radiation source with an emission peak in the wavelength range between 390 nm and 780 nm; and
a controller that can control the sources independently of each other, wherein the controller can adapt the amount and type of radiation based on sensor data, date & time and/or a stored list of target data to regulate the growth of the organism.

18. A system for growth control of plant-like organisms according to claim 17, wherein the first radiation source has an emission peak in the wavelength range between 200 nm and 240 nm.

19. A system for growth control of plant-like organisms according to claim 17, wherein the second radiation source has an emission peak in the wavelength range between 600 and 760 nm.

20. A method for growth control of plant-like organisms comprising:
a first exposure with radiation with a peak in the wavelength range between 200 nm and 240 nm; and
a second exposure with radiation with a peak in the wavelength range between 390 nm and 500 nm or between 600 and 760 nm, which ends later than the first exposure.
